(19) United States
(12) Patent Application Publication
(10) Pub. No.: US 2011/0144837 A1
(43) Pub. Date: Jun. 16, 2011

(54) HYBRID ACCESSORY POWER MODULE SHEDDING FOR HIGH VOLTAGE BATTERY PROTECTION

(75) Inventors: Adam J. Heisel, Garden City, MI (US); John L. Lahti, Novi, MI (US); Anthony H. Heap, Ann Arbor, MI (US)

(73) Assignee: GM GLOBAL TECHNOLOGY OPERATIONS, INC., Detroit, MI (US)

(21) Appl. No.: 12/634,735

(22) Filed: Dec. 10, 2009

(51) Int. Cl. B60W 20/00; H02J 7/04

(52) U.S. Cl. 701/22; 320/162; 903/907

(57) ABSTRACT

A method of controlling a hybrid powertrain of a vehicle includes lowering a target voltage set point of a low voltage battery to a temporary voltage set point to reduce the overall power required by the accessory power module when a requested voltage from a vehicle accessory draws the voltage of the low voltage battery below the target voltage set point. The temporary voltage set point gradually increases over time until equal to the target voltage set point, allowing sufficient time for a high voltage battery to provide the required power for the accessory power module or for an electric motor/generator to generate the current required by the accessory power module.

### TECHNICAL FIELD

The invention generally relates to a vehicle, and more specifically to a method of controlling a hybrid powertrain of the vehicle.

### BACKGROUND OF THE INVENTION

Hybrid powertrains typically include, but are not limited to, an engine, an electric motor/generator, a high voltage battery and a low voltage battery. The electric motor/generator charges the high voltage battery, which in turn powers an Accessory Power Module (APM). The APM in turn powers the low voltage battery, which is used to power various vehicular accessories.

As is known in many hybrid powertrains, the hybrid powertrain switches between operational states, in which the vehicle is powered by the engine, the electric motor/generator or a combination of the engine and the electric motor/generator. The high voltage battery supplies electricity to the electric motor/generator when the electric motor/generator is powering the vehicle, and the engine provides torque to the electric motor/generator to generate electricity, and thereby charge the high voltage battery.

It is desirable to maintain a charge on the low voltage battery above a target voltage set point, i.e., a pre-determined level. Typically, the target voltage set point for the low voltage battery is above 12.5 volts. During normal operation, the high voltage battery provides the necessary charge through the APM to maintain the low voltage battery at or above the target voltage set point. However, if the voltage of the low voltage battery drops below the target voltage set point and the high voltage battery is in a weakened state, i.e., during very high or low temperatures, in a low power condition, or is otherwise not functioning properly, then the electric motor/generator may be engaged to generate electricity and bring the voltage of the low voltage battery back to a level greater than the target voltage set point, i.e., the electric motor/generator re-charges the low voltage battery. Accordingly, in order for the electric motor/generator to re-charge the low voltage battery, the engine must increase the torque supplied to the electric motor/generator.

As noted above, the high voltage battery provides electricity to the APM, which powers and controls at least one of a plurality of vehicle accessories and/or systems. The accessories may include, but are not limited to, headlights, turn signals, power windows, power seats, brake lights, etc. The accessory power module responds to power requests from the various accessories very quickly, often near a rate of approximately 4 kHz, to supply the accessory with electric power. A quick draw of electric power quickly drops the voltage, i.e., charge, of the low voltage battery. Once the voltage of the low voltage battery drops below the target voltage set point, the engine is engaged to supply torque to the electric motor/generator to quickly re-charge the low voltage battery. However, the rate at which the engine can increase the torque supplied to the electric motor/generator is slower than the rate at which the accessory power module acts, causing the electric motor/generator to lag behind, and reduce the performance of the vehicle.

### SUMMARY OF THE INVENTION

A method of controlling a hybrid powertrain of a vehicle is disclosed. The vehicle includes an accessory power module configured for supplying an electric current to a low voltage battery to power at least one vehicle accessory. The hybrid powertrain includes a high voltage battery configured for providing an electric current to the accessory power module. The method includes comparing the present voltage of the low voltage battery to a target voltage set point to determine a requested power from the accessory power module. The method further includes calculating an un-constrained required power output for the high voltage battery based upon a current power output from the high voltage battery and the requested power from the accessory power module. The method further includes limiting the un-constrained required power output for the high voltage battery to define a constrained power output of the high voltage battery; and lowering the target voltage set point to a temporary voltage set point when the constrained power output is less than the un-constrained required power output.

In another aspect of the invention, a method of controlling a hybrid powertrain of a vehicle is disclosed. The vehicle includes an accessory power module configured for supplying an electric current to a low voltage battery to power at least one vehicle accessory. The hybrid powertrain includes a high voltage battery configured for providing an electric current to the accessory power module. The method includes sensing a present voltage of the low voltage battery. The method further includes calculating a required power output from the accessory power module based upon a defined target voltage set point and the sensed present voltage of the low voltage battery. The method further includes calculating a current power output from the high voltage battery. The method further includes calculating an un-constrained required power output for the high voltage battery based upon the current power output from the high voltage battery and the requested power from the accessory power module. The method further includes applying a set of operational limits to the un-constrained required power output for the high voltage battery to define a constrained power output of the high voltage battery based upon a current operating condition of the high voltage battery; and lowering the target voltage set point to a temporary voltage set point when the constrained power output is less than the un-constrained required power output.

Accordingly, the method decreases the target voltage set point to reduce the power, i.e., voltage, required by the accessory power module during activation of one of the vehicle accessories. Decreasing the target voltage set point prevents the high voltage battery from having to instantaneously provide all of electric power requested by the accessory power module. Therefore, the power output of the electric motor/generator may be increased gradually with the temporary voltage set point increasing in proportion to the increase in the power output from the electric motor/generator. Increasing the temporary voltage set point in relation to the increase in the power output from the electric motor/generator provides for a smooth transition upon actuation of the accessory, reduces the possibility of stalling the engine by instantaneously attempting to increase the power output of the electric motor/generator, and increases the overall efficiency of the hybrid powertrain.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic drawing of a hybrid powertrain of a vehicle.

FIG. 2 is a flowchart showing the steps of a method of controlling the hybrid powertrain.

### DESCRIPTION OF THE PREFERRED EMBODIMENTS

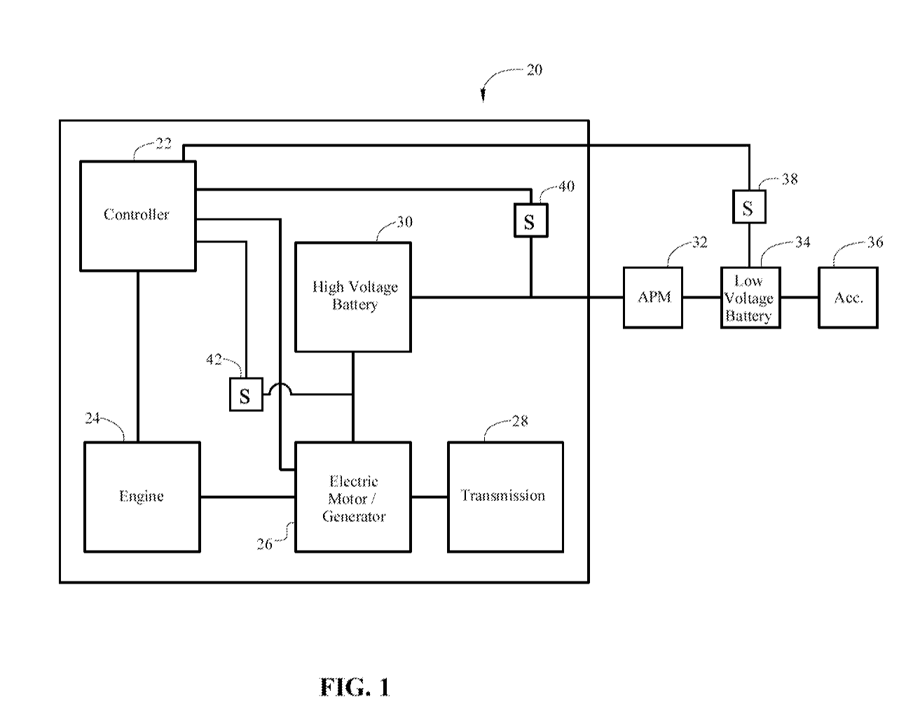

Referring to FIG. 1, wherein like numerals indicate like parts throughout the several views, a hybrid powertrain of a vehicle is shown schematically at 20. As described herein, the hybrid powertrain 20 may include a controller 22, an engine 24, an electric motor/generator 26, a transmission 28 and a high voltage battery 30. The hybrid powertrain 20 may utilize the engine 24 to generate a torque, which is supplied to the electric motor/generator 26 to generate electricity. The electricity is stored in the high voltage battery 30. Alternatively, the torque from the engine 24 may be used to generate a torque, which is supplied to the transmission 28 to power the vehicle. The electric motor/generator 26 may also draw a current from the high voltage battery 30, which is utilized to generate a torque, which is supplied to the transmission 28 to power the vehicle. It should be appreciated that other configurations of hybrid powertrain 20 may exist, and that the operation of the hybrid powertrain 20 may differ from that described herein.

The engine 24 may include, but is not limited to, an internal combustion engine 24. It should be appreciated that other types of engines may alternatively be utilized in the hybrid powertrain 20. The engine 24 is in communication with the controller 22, with the controller 22 configured for controlling the operation of the engine 24. The specific type, style, size and/or configuration of the engine 24 is not pertinent to the method disclosed. Accordingly, the engine 24 is not described in detail herein.

The transmission 28 may include any transmission 28 capable of converting the torque from the electric motor/generator 26 and/or the engine 24 into a slower or faster rotational output as is known. The transmission 28 is in communication with the controller 22, with the controller 22 configured for controlling the operation of the transmission 28. The specific type, style, size and/or configuration of the transmission 28 is not pertinent to the method disclosed. Accordingly, the transmission 28 is not described in detail herein.

The electric motor/generator 26 includes a motor portion for converting electric power into torque and a generator portion for converting torque into electricity as is known. The electric motor/generator 26 may include any electric motor/generator 26 suitable for use in hybrid vehicles. The electric motor/generator 26 is in communication with the controller 22, with the controller 22 configured for controlling the operation of the electric motor/generator 26. The specific type, style, size and/or configuration of the electric motor/generator 26 is not pertinent to the method disclosed. Accordingly, the electric motor/generator 26 is not described in detail herein.

The controller 22 controls the operation of the hybrid powertrain 20, including the engine 24, the transmission 28 and the electric motor/generator 26. The controller 22 may include a computer, including all memory, software and hardware necessary to operate the controller 22. The specific type, style, size and/or configuration of the controller 22 is not pertinent to the method disclosed. Accordingly, the controller 22 is not described in detail herein.

The vehicle includes an Accessory Power Module (APM 32). The APM 32 is in communication with the controller 22. The APM 32 receives voltage, i.e. an electric current from the high voltage battery 30. The APM 32 supplies a low voltage battery 34 with the electric current to power at least one vehicle accessory 36. The APM 32 controls the operation of the at least one vehicle accessory 36. The vehicle accessories 36 may include, but are not limited to, headlights, tail lights, brake lights, power windows, power seats, audio devices, video devices, etc. Each of the accessories 36 requires a specific voltage to operate. Upon actuation of one of the accessories 36, the APM 32 directs voltage from the low voltage battery 34, which in turn provides voltage, i.e., an electric current, to the accessory 36 to operate the accessory 36.

As is well known, vehicle accessories 36 operate on a 12 volt system. Accordingly, the low voltage battery 34 must maintain a minimum voltage slightly above 12 volts. Typically, the minimum voltage is set above 12.5 volts. This is commonly referred to as a target voltage set point of the low voltage battery 34. During normal operations, the high voltage battery 30 continuously charges the low voltage battery 34 to maintain the voltage of the low voltage battery 34 above the target voltage set point. However, if the high voltage battery 30 is in a weakened state, such as during extreme high and/or low temperatures, during low engine power conditions, or if the high voltage battery 30 is otherwise not functioning properly, the voltage of the low voltage battery 34 may drop below the target voltage set point. If the voltage of the low voltage battery 34 drops below the target voltage set point, the engine 24 may be engaged to supply the electric motor/generator 26 with torque to generate electricity and re-charge the low voltage battery 34 through the APM 32, i.e., bring the voltage of the low voltage battery 34 up to a level equal to or greater than the target voltage set point. However, the response time of the engine 24 necessary to supply the torque to the electric motor/generator 26 lags behind the response time of the APM 32, which is the time required to provide the voltage to the accessory 36.

The hybrid powertrain 20 may further include one or more sensors for sensing data related to various aspects of the hybrid powertrain 20. As shown, the hybrid powertrain 20 includes a battery voltage sensor 38, an APM current sensor 40, and an electric motor/generator current sensor 42.

The battery voltage sensor 38 is configured for continuously sensing the present voltage of the low voltage battery 34. The battery voltage sensor 38 is in communication with the controller 22, with the present voltage of the low voltage battery 34 communicated to the controller 22.

The APM current sensor 40 is configured for sensing the current draw by the APM 32 from the high voltage battery 30 upon actuation of one or more accessories 36. When one or more accessories 36 is actuated, the accessories 36 draw power, i.e., and electric current, from the low voltage battery 34, which in turn draws power, i.e., an electric current, from the APM 32. The APM 32 voltage sensor senses the amount of current drawn by the APM 32 in order to operate the accessories 36. The APM current sensor 40 is in communication with the controller 22, with the sensed requested current from the APM 32 being communicated to the controller 22. It should be appreciated that each accessory 36 may draw a different power, and that multiple accessories 36 may draw an electric current simultaneously.

The electric motor/generator current sensor 42 is configured for sensing the current draw by the electric motor/generator 26 from the high voltage battery 30. The electric motor/generator current sensor 42 is in communication with the controller 22, with the sensed current power draw from the high voltage battery 30 to the electric motor/generator 26 being communicated to the controller 22. It should be appreciated that the current draw by the electric motor/generator 26 from the high voltage battery 30 is dependent upon and varies with the torque being produced by the electric motor/generator 26.

In order to prevent or minimize rough and/or inefficient operation of the engine 24 in response to the APM 32 directing a voltage draw that lowers the voltage of the low voltage battery 34 below the target voltage set point when the high voltage battery 30 is in a weakened state or is otherwise unable to supply the electric current to the APM 32, the disclosed method temporarily lowers the target voltage set point of the low voltage battery 34. Temporarily lowering the target voltage set point provides the high voltage battery 30 time to charge the low voltage battery 34. If for some reason the high voltage battery 30 is unable to charge the low voltage battery 34, then the engine 24 may be engaged to provide torque to the electric motor/generator 26 so that the electric motor/generator 26 may then charge the low voltage battery 34. The controller 22 may then gradually increase the temporary set point, in relation to a gradual increase in the power output from the electric motor/generator 26, back to the target voltage set point.

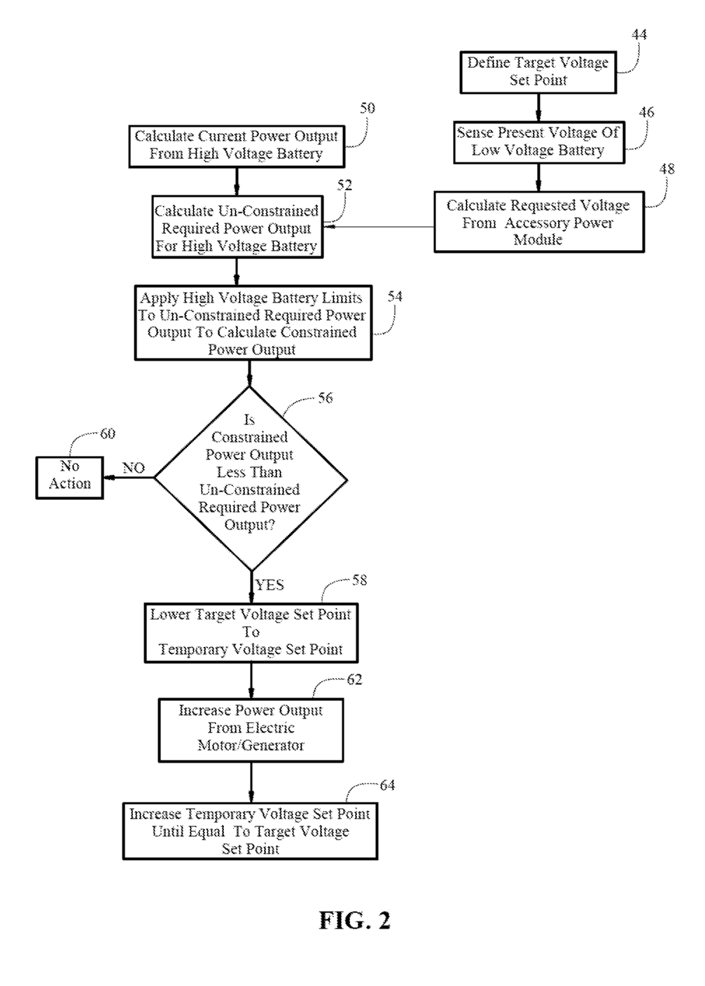

Referring to FIG. 2, a method of controlling the hybrid powertrain 20 is shown. The method of controlling the hybrid powertrain 20 includes defining the target voltage set point (block 44). As described above, the target voltage set point is typically set at 12.5 volts. However, it should be appreciated that the target voltage set point may be set to any value greater than 12.5 volts.

The method further includes sensing the present voltage of the low voltage battery 34 (block 46). As described above, the hybrid powertrain 20 uses the battery voltage sensor 38 to continuously sense the present voltage of the low voltage battery 34. However, it should be appreciated that the present voltage of the low voltage battery 34 may be sensed in some other manner with other sensors not shown or described herein.

The method further includes comparing the present voltage of the low voltage battery 34 to the target voltage set point to determine a requested power from the APM 32 (block 48). The controller 22 may calculate the requested power from the APM 32 by taking the difference between the target voltage set point and the present voltage of the low voltage battery 34. However, it should be appreciated that the requested power from the APM 32 may be calculated in some other suitable manner.

The method further includes calculating a current power output from the high voltage battery 30 (block 50). The current power output from the high voltage battery 30 may be calculated by the controller 22 using data provided by the APM current sensor 40 and the electric motor/generator current sensor 42. Specifically, the current power output of the high voltage battery 30 may be calculated by summing the sensed current measured by the APM current sensor 40, i.e., the power drawn by the APM 32, with the sensed current measured by the electric motor/generator current sensor 42, i.e., the power drawn by the electric motor/generator 26.

The method further includes calculating an un-constrained required power output for the high voltage battery 30 (block 52). The un-constrained required power output for the high voltage battery 30 is the total amount of electric power the high voltage battery 30 is required to provide to power the electric motor/generator 26 and the APM 32. Accordingly, the required power output for the high voltage battery 30 is based upon the current power output from the high voltage battery 30 and the requested power output from the APM 32.

The method further includes limiting the un-constrained required power output from the high voltage battery 30 to define a constrained power output of the high voltage battery 30 (block 54). Limiting the un-constrained required power output for the high voltage battery 30 may further be defined as applying a set of operational limits to the un-constrained required power output of the high voltage battery 30. The operational limits may include a maximum and a minimum allowable voltage for the high voltage battery 30 for given operating and/or environmental conditions. For example, the maximum and minimum allowable voltage output for the high voltage battery 30 may be limited for extreme high and/or low temperatures, when the electric motor/generator 26 or the engine 24 are operating at a slow speed, or when the high voltage battery 30 is in a weakened condition or is otherwise not functioning at an optimum level. Accordingly, the method further includes defining the set of operational limits for the high voltage battery 30 based upon possible operating condition of the high voltage battery 30 to prevent damage to the high voltage battery 30. The set of operational limits may be embodied as a table saved in the memory of the controller 22, which the controller 22 references, by an equation saved in the memory of the controller 22, which the controller 22 solves, or in some other suitable manner.

The method further includes determining if the constrained power output is less than the un-constrained required power output (block 56). When the constrained power output of the high voltage battery 30 is less than the un-constrained required power output for the high voltage battery 30, the method further includes lowering the target voltage set point to a temporary voltage set point (block 58). Accordingly, if the requested power from the APM 32 draws the voltage of the low voltage battery 34 down below the target voltage set point, the target voltage set point of the low voltage battery 34 is lowered to the temporary voltage set point to ensure that the high voltage battery 30 is not engaged in an attempt to instantaneously supply all of the requested power from the APM 32. If the constrained power output of the engine 24 is equal to or greater than the un-constrained required power output for the engine 24, then no action is taken (block 60).

The method further includes gradually increasing the current power output of the electric motor/generator 26 over time (block 62). Accordingly, once the target voltage set point is lowered to the temporary voltage set point, the power of the electric motor/generator 26 is gradually increased, in order to increase the electric power supplied to the high voltage battery 30 and/or the APM 32. It should be appreciated that the controller 22 manipulates the operation of the electric motor/generator 26 to gradually increase the current power output of the electric motor/generator 26. In this manner, the speed of the electric motor/generator 26, and possible the corresponding speed of the engine 24 powering the electric motor/generator 26, may be increased smoothly in the most efficient manner.

The method further includes gradually increasing the temporary voltage set point over time until the temporary voltage set point is equal to the target voltage set point (block 64). Gradually increasing the temporary voltage set point over time may further be defined as gradually increasing the temporary voltage set point over time in relation to the increased current power output of the high voltage battery 30 and/or the electric motor/generator 26. As such, as the power output of the high voltage battery 30 is gradually increased, the temporary voltage set point is also gradually increased in corresponding fashion. In this manner, the hybrid powertrain 20 gradually increases the torque to the electric motor/generator 26, which allows the electric motor/generator 26 to gradually increase the generation of electricity to charge the high voltage battery 30, which supplies the APM 32, which in turn charges the low voltage battery 34 until the low voltage battery 34 is brought up to a level equal to or greater than the target voltage set point.

While the best modes for carrying out the invention have been described in detail, those familiar with the art to which this invention relates will recognize various alternative designs and embodiments for practicing the invention within the scope of the appended claims.

1. A method of controlling a hybrid powertrain of a vehicle having an accessory power module configured for supplying an electric current to a low voltage battery to power at least one vehicle accessory, the hybrid powertrain including a high voltage battery configured for providing an electric current to the accessory power module, the method comprising:
comparing the present voltage of the low voltage battery to a target voltage set point to determine a requested power from the accessory power module;
calculating an un-constrained required power output for the high voltage battery based upon a current power output from the high voltage battery and the requested power from the accessory power module;
limiting the un-constrained required power output for the high voltage battery to define a constrained power output of the high voltage battery; and
lowering the target voltage set point to a temporary voltage set point when the constrained power output is less than the un-constrained required power output.

2. A method as set forth in claim 1 further comprising gradually increasing the temporary voltage set point over time until the temporary voltage set point is equal to the target voltage set point.

3. A method as set forth in claim 2 further comprising defining the target voltage set point.

4. A method as set forth in claim 3 wherein defining the target voltage set point is further defined as defining the target voltage set point to equal to 12.5 volts.

5. A method as set forth in claim 2 wherein the hybrid powertrain further includes an electric motor/generator and wherein the method further comprises gradually increasing the current power output of the electric motor/generator over time.

6. A method as set forth in claim 5 wherein gradually increasing the temporary voltage set point over time is further defined as gradually increasing the temporary voltage set point over time in relation to the increased current power output of the electric motor/generator.

7. A method as set forth in claim 1 further comprising sensing the present voltage of the low voltage battery.

8. A method as set forth in claim 7 further comprising calculating a current power output from the high voltage battery.

9. A method as set forth in claim 1 wherein limiting the un-constrained required power output is further defined as applying a set of operational limits to the un-constrained required power output.

10. A method as set forth in claim 9 further comprising defining a set of operational limits for the high voltage battery based upon possible operating conditions of the high voltage battery to prevent damage to the high voltage battery.

11. A method of controlling a hybrid powertrain of a vehicle having an accessory power module configured for supplying an electric current to a low voltage battery to power at least one vehicle accessory, the hybrid powertrain including a high voltage battery configured for providing an electric current to the accessory power module, the method comprising:
sensing a present voltage of the low voltage battery;
calculating a required power output from the accessory power module based upon a defined target voltage set point and the sensed present voltage of the low voltage battery;
calculating a current power output from the high voltage battery;
calculating an un-constrained required power output for the high voltage battery based upon the current power output from the high voltage battery and the requested power from the accessory power module;
applying a set of operational limits to the un-constrained required power output for the high voltage battery to define a constrained power output of the high voltage battery based upon a current operating condition of the high voltage battery; and
lowering the target voltage set point to a temporary voltage set point when the constrained power output is less than the un-constrained required power output.

12. A method as set forth in claim 11 further comprising gradually increasing the temporary voltage set point over time until the temporary voltage set point is equal to the target voltage set point.

13. A method as set forth in claim 12 wherein the hybrid powertrain further includes an electric motor/generator and wherein the method further comprises gradually increasing the current power output of the electric motor/generator over time.

14. A method as set forth in claim 13 wherein gradually increasing the temporary voltage set point over time is further defined as gradually increasing the temporary voltage set point over time in relation to the increased current power output of the electric motor/generator.

15. A method as set forth in claim 14 further comprising defining the target voltage set point.

16. A method as set forth in claim 15 wherein defining the target voltage set point is further defined as defining the target voltage set point to equal or be greater than 12.5 volts.
